(19) United States
(12) Patent Application Publication
(10) Pub. No.: US 2024/0386798 A1
(43) Pub. Date: Nov. 21, 2024

(54) SYSTEM AND METHOD OF CONTROLLING TRAFFIC SIGNAL

(71) Applicant: REXGEN CO., LTD., Anyang-si (KR)

(72) Inventor: Soon Hyun AHN, Anyang-si (KR)

(21) Appl. No.: 18/785,761

(22) Filed: Jul. 26, 2024

Related U.S. Application Data
(63) Continuation of application No. PCT/KR2023/001840, filed on Feb. 8, 2023.

(30) Foreign Application Priority Data
Feb. 21, 2022 (KR) 10-2022-0022535
May 25, 2022 (KR) 10-2022-0063953

(51) Int. Cl. G08G 1/08

(52) U.S. Cl. CPC G08G 1/08

(57) ABSTRACT

A system for controlling a traffic signal according to an embodiment of the disclosure includes a template generating unit configured to generate a first template related to a lane and a second template related to an opposite lane of the lane based on object information detected by analyzing a lane image; and a simulation unit configured to display adjacently the first template and the second template

### CROSS-REFERENCE TO RELATED APPLICATIONS

This application is a Bypass continuation of pending PCT International Application No. PCT/KR2023/001840, which was filed on Feb. 8, 2023, and which claims priorities under 35 U.S.C 119(a) to Korean Patent Application No. 10-2022-0022535 filed with the Korean Intellectual Property Office on Feb. 21, 2022, and Korean Patent Application No. 10-2022-0063953 filed with the Korean Intellectual Property Office on May 25, 2022. The disclosures of the above patent applications are incorporated herein by reference in their entirety.

### TECHNICAL FIELD

The disclosure relates to a system and a method of controlling a traffic signal.

### BACKGROUND ART

Research using results obtained by analyzing an image of a camera has been actively done in recent years. Specially, many researches and tries for optimizing and making efficient traffic flow by analyzing an image of a lane have been done in traffic field.

Conventional technique uses an optimal signal controlling method of detecting a vehicle in a lane image and calculating traffic volume by making data with the detected result, to realize a signal system for optimal traffic flow. However, the signal controlling method can't respond rapidly in a traffic situation changed in real time. Additionally, it is difficult to maximize traffic flow because a system for controlling intuitively the traffic flow using real road environment and a traffic system does not exist.

### SUMMARY

The disclosure is to provide a system and a method of controlling a traffic signal for providing a display showing road situation based on a lane image. Additionally, the disclosure is to provide a system and a method of controlling a traffic signal in which a user can simulate a situation of traffic based on real-time traffic information obtained by analyzing the lane image.

Aspects of the disclosure are not limited as aspects mentioned above, and another aspect not mentioned will be clearly understood by a person in the art from following description.

A system for controlling a traffic signal according to an embodiment of the disclosure includes a template generating unit configured to generate a first template related to a lane and a second template related to an opposite lane of the lane based on object information detected by analyzing a lane image; and a simulation unit configured to display the first template and the second template.

A method of controlling a traffic signal according to an embodiment of the disclosure includes generating a first template related to a lane and a second template related to an opposite lane of the lane based on object information detected by analyzing a lane image; and displaying the first template and the second template.

A system and a method of controlling a traffic signal according to disclosure may generate a template related to a lane and a template related to an opposite lane based on a lane image and display simultaneously the generated templates and the lane image, and thus a user may perceive intuitively traffic situation of a road.

A system and a method of controlling a traffic signal according to disclosure may generate a template corresponding to traffic situation of an intersection, display the generated template and provide a user interface screen changeable a cut line for controlling the traffic signal, and so the user can simulate control of traffic flow and maximize the traffic flow through the simulating.

A system and a method of controlling a traffic signal according to disclosure may shift automatically a cut line of other lanes and display the shifted cut line when a cut line of a lane is changed, thereby providing a convenient simulation environment.

Additionally, various effects perceived directly or indirectly through the disclosure may be provided.

### BRIEF DESCRIPTION OF DRAWINGS

FIG. 1 is a view illustrating environment of a system for controlling a traffic signal according to an embodiment of the disclosure;

FIG. 2 is a view illustrating an example of obtaining a lane image using a system for controlling a traffic signal according to an embodiment of the disclosure;

FIG. 3 is a view illustrating an example of a lane image obtained by using a system for controlling a traffic signal according to an embodiment of the disclosure;

FIG. 4 is a block diagram illustrating a system for controlling a traffic signal according to an embodiment of the disclosure;

FIG. 5 is a view illustrating an example of calculating accumulation capacity using a system for controlling a traffic signal according to an embodiment of the disclosure;

FIG. 6A and FIG. 6B are views illustrating an example showing a template generated by a system for controlling a traffic signal according to an embodiment of the disclosure;

FIG. 7 is a view illustrating an example of calculating occupancy based on accumulation capacity in a system for controlling a traffic signal according to an embodiment of the disclosure;

FIG. 8 is a view illustrating an example of setting a cut line using a system for controlling a traffic signal according to an embodiment of the disclosure;

FIG. 9 is a view illustrating an example marking a cut line using a system for controlling a traffic signal according to an embodiment of the disclosure;

FIG. 10A and FIG. 10B are views illustrating an example of showing a template generated by a system for controlling a traffic signal according to another embodiment of the disclosure;

FIG. 11 is a view illustrating an example of marking a cut line using a system for controlling a traffic signal according to another embodiment of the disclosure; and

FIG. 12 is a flowchart illustrating a process of controlling a traffic signal according to an embodiment of the disclosure.

### DETAILED DESCRIPTION

Hereinafter, embodiments of the disclosure will be described in detail with reference to accompanying drawings. It should be understood that the same numbers refer to the same elements throughout the description of the figures. Detailed description concerning related known constitution or function will be omitted if it is determined that the related known constitution or function hinders understanding of embodiments of the disclosure.

It will be understood that, although the terms first, second, A, B, (a), (b), etc. may be used herein to describe various elements, these elements should not be limited by these terms. These terms are only used to distinguish one element from another. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

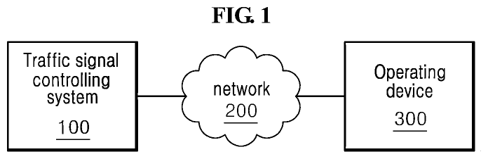

FIG. 1 is a view illustrating environment of a system for controlling a traffic signal according to an embodiment of the disclosure.

In FIG. 1, a system 100 for controlling a traffic signal according to present embodiment may communicate with an operating device 300 through a network 200.

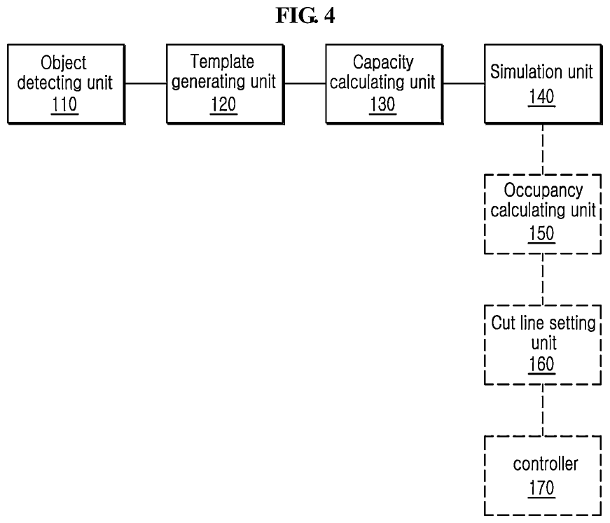

In an embodiment, the system 100 may transmit information related to at least one of an object detected by an object detecting unit 110, a template generated by a template generating unit 120, accumulation capacity calculated by a capacity calculating unit 130, information displayed by a simulation unit 140, occupancy calculated by an occupancy calculating unit 150, a cut line set by a cut line setting unit 160 and a signal time controlled by a controller 170 to the operating device 300, as shown in FIG. 4.

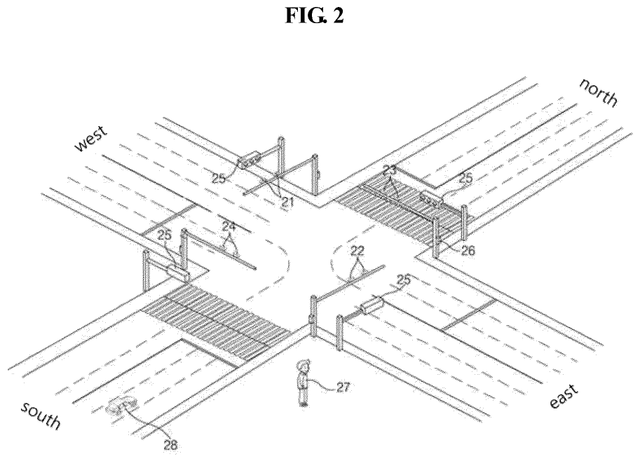

FIG. 2 is a view illustrating an example of obtaining a lane image using a system for controlling a traffic signal according to an embodiment of the disclosure.

In FIG. 2, a system for controlling a traffic signal (for example the system 100 for controlling a traffic signal in FIG. 4) of the present embodiment may obtain a lane image. For example, a lane may include an intersection, and the system for controlling the traffic signal (for example the system 100 in FIG. 4) may obtain the lane image from an image photographing device 21, 22, 23 or 24 located on the intersection. In an embodiment, the image photographing device 21, 22, 23 or 24 may include a camera or an image sensor.

In an embodiment, a first image photographing device 21 may photograph a lane located in the east, a second image photographing device 22 may photograph a lane located in the west, a third image photographing device 23 may photograph a lane located in the south, and a fourth image photographing device 24 may photograph a lane located in the north. FIG. 2 illustrates an intersection (four-way stop), but it is not limited as the intersection. The intersection may mean a lane including a place at which two or more entry/exit lanes using a traffic signal system meet. For example, the intersection may indicate bidirectional lane including a pedestrian crossing signal system and a crosscut lane as well as a three-way intersection, a four-way intersection or a five-way intersection used commonly.

The image photographing device 21, 22, 23 or 24 may photograph an object 27 or 28 on a road. For example, the object on the road may include a pedestrian 27 and a vehicle 28.

In an embodiment, the system for controlling the traffic signal (for example the system 100 in FIG. 4) may be included in at least one of a signal light 25, a signal controller 26, the image photographing device 21, 22, 23 or 24 and an operating device 300. However, it is not limited. The system for controlling the traffic signal (for example the system 100 in FIG. 4) may be included in an external server or exist as an extra device.

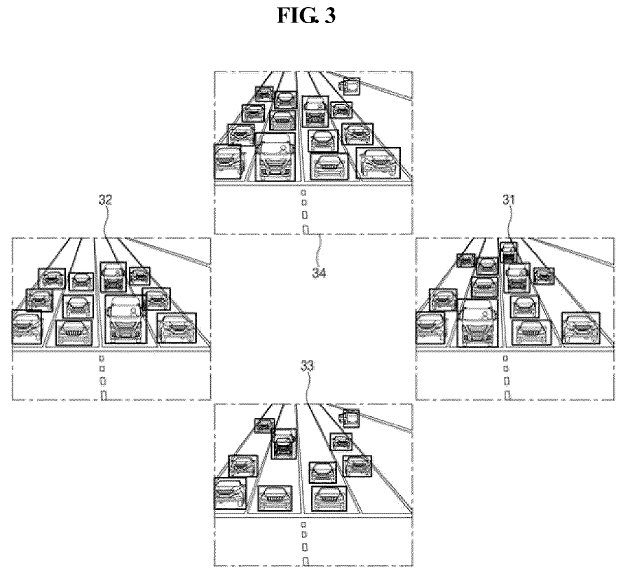

FIG. 3 is a view illustrating an example of a lane image obtained by using a system for controlling a traffic signal according to an embodiment of the disclosure.

In FIG. 3, a system for controlling a traffic signal (for example the system 100 in FIG. 4) of the present embodiment may obtain image 31, 32, 33 or 34 photographed by the image photographing device in FIG. 2. For example, the system for controlling the traffic signal (the system 100 in FIG. 4) may obtain a first lane image 31 by photographing a lane located in an east direction of a first image photographing device (for example the first image photographing device 21 in FIG. 2) and obtain a second lane image 32 by photographing the lane located in a west direction of a second image photographing device (for example the second image photographing device 22 in FIG. 2). The first lane image 31 and the second lane image 32 may be images of lanes opposed each other.

Furthermore, a third lane image 33 and a fourth lane image 34 may be images of lanes opposed each other, wherein the third lane image 33 is obtained by photographing a lane in a south direction of a third image photographing device (for example the third image photographing device 23 in FIG. 2), and the fourth lane image 34 is obtained by photographing a lane in a north direction of a fourth image photographing device (for example the fourth image photographing device 24 in FIG. 2).

In an embodiment, the opposite lane is reverse concept of conflict and may mean at least one lane passable at simultaneous entry signal in the intersection. For another example, the opposite lane may include a lane in a reverse direction of the lane.

The system for controlling the traffic signal (for example the system 100 in FIG. 4) may detect an object based on the lane image 31, 32, 33 or 34 photographed by the image photographing device, generate a template and control a traffic signal by setting a cut line.

FIG. 4 is a block diagram illustrating a system for controlling a traffic signal according to an embodiment of the disclosure.

In FIG. 4, the system 100 for controlling the traffic signal according to the present embodiment may include the object detecting unit 110, the template generating unit 120, the capacity calculating unit 130 and the simulation unit 140.

The object detecting unit 110 may detect object information by analyzing a lane image. For example, the object detecting unit 110 may detect an object included in a lane and passage information based on the lane image. In an embodiment, the passage information may comprise object information (for example including type of a vehicle such as a sedan, a van, a bus, a truck, etc. and size of the vehicle such as small size, medium size, large size, etc.) for each of lanes, the number of the vehicle and a waiting order when the object is the vehicle. In an embodiment, the passage information may include further one or more of a distance between vehicles, a vehicle number, a color of the vehicle, stop or not and driving or not. In an embodiment, the object may include the vehicle, a pedestrian, a traffic facility and so on. In the present embodiment, the object may be the vehicle.

In an embodiment, the lane image may include an entry lane image of the intersection. For example, the object detecting unit 110 may obtain the lane image from the image photographing device 21, 22, 23 or 24 established at the intersection. For another example, the object detecting unit 110 may detect an object on multiple lanes. For still another example, the object detecting unit 110 may detect a vehicle based on an intersection entry lane image obtained by photographing the front of the vehicle located in an entry direction of the intersection. In an embodiment, the object detecting unit 110 may detect the rear of a vehicle on the basis of an intersection exit lane image obtained by photographing the vehicle driven in an exit direction of the intersection, except the vehicle located in the entry direction of the intersection.

The template generating unit 120 may generate a first template related to a lane and a second template related to an opposite lane of the lane based on object information. For example, the template generating unit 120 may generate the first template and the second template based on a first lane image and a second lane image corresponding to the first lane image of the lane image. For example, the first lane image may be an image of an entry lane of a first intersection, and the second lane image may be an image of an entry lane of a second intersection which is an opposite lane of the first intersection entry lane. In this case, the template generating unit 120 may generate the first template and the second template indicating imaginary opposite lane by converting the image of the entry lane of the first intersection and the image of the entry lane of the second intersection in a view point, normalizing objects detected from the image of the entry lane of the first intersection and the image of the entry lane of the second intersection and disposing again the normalized objects in certain interval.

In an embodiment, the template generating unit 120 may generate a template by normalizing the object detected by the object detecting unit 110 in a figure based on passage information detected by the object detecting unit 110. For example, the figure may include a block shape. For another example, the template generating unit 120 may convert the object into a block with a size corresponding to objection information. In an embodiment, the template generating unit 120 may convert an object such as a bus or a truck into a block having a size greater than a block of a sedan having relatively small size. In an embodiment, the template generating unit 120 may convert the object into a block with preset size based on the object information. In an embodiment, the template generating unit 120 may convert an environmental object such as a lane, a lane marking, various traffic facilities or geometrical road structure (for example slope, linear shape, branch, junction, etc.) in a digital twin by 3D-modeling the environmental object. In this case, the template generating unit 120 may reduce resource of a processor by converting simply the environmental object into a block. The capacity calculating unit 130 may calculate accumulation capacity of each of objects for each of lanes included in the lane and the opposite lane based on the object information.

In an embodiment, the capacity calculating unit 130 may calculate accumulation capacity of an object for each of lanes based on a type, a number and an order of the object. For example, the capacity calculating unit 130 may calculate the accumulation capacity of each of objects by giving traffic capacity greater than traffic capacity of a small size vehicle to a large size vehicle.

In an embodiment, the capacity calculating unit 130 may give traffic capacity of each of objects based on a capacity correction factor and calculate accumulation capacity of each of objects depending on the traffic capacity of each of objects. For example, the capacity correction factor may include a heavy vehicle correction factor or a sedan scale factor. For another example, the capacity calculating unit 130 may set respectively 1, 2 and 3 to a small size vehicle, a medium size vehicle and a large size vehicle in view of weight and calculate the accumulation capacity depending on the setting. However, a method of calculating the accumulation capacity is not limited as the method mentioned above. The capacity calculating unit 130 may set different weight according to a type of the object and calculate the accumulation capacity depending on the setting.

In an embodiment, the capacity calculating unit 130 may calculate the accumulation capacity of each of object according to the traffic capacity given to each of objects based on the capacity correction factor. For example, the capacity calculating unit 130 may calculate accumulation capacity of a target object by summating traffic capacity of the target object and traffic capacity of an object waiting in front of the target object in a direction of a stop line on the basis of the target object.

In an embodiment, the capacity calculating unit 130 may correct the accumulation capacity further considering at least one of heavy vehicle ratio, waiting order for each of lanes, distribution for each of types of objects, slope of a road, linear shape of a road, branch of the road and junction of the road.

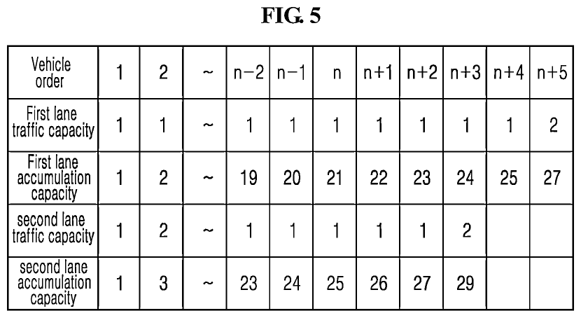

FIG. 5 is a view illustrating an example of calculating accumulation capacity using a system for controlling a traffic signal according to an embodiment of the disclosure.

In FIG. 5, the capacity calculating unit 130 in the system 100 for controlling the traffic signal according to the present embodiment may calculate accumulation capacity of an object for each of lanes. For example, the capacity calculating unit 130 may calculate accumulation capacity of each of objects waiting on a first lane and accumulation capacity of each of objects waiting on a second lane when two lanes exist.

FIG. 5 shows a case that two lanes exist, but it is not limited. The capacity calculating unit 130 may calculate accumulation capacity of each of objects for x lane when x lane exists.

Now referring to FIG. 4, the simulation unit 140 may dispose a template, of each of lane images generated through a lane image of at least one lane and a lane image of an opposite lane, at a location adjacent to each of lane images when it displays the template, and include a traffic control simulation user interface (UI) for setting and displaying a location of a cut line on the template of each of the lane images according to user's input.

Accordingly, the user (operator or manager) may identify intuitively a waiting line of the lane based on the template displayed through the traffic control simulation UI. Additionally, the user (operator or manager) may dispose, delete or vary randomly block-type object on the template displayed through the traffic control simulation UI. That is, the user may simulate a setting of a cut line for signal control and signal control through the traffic control simulation UI.

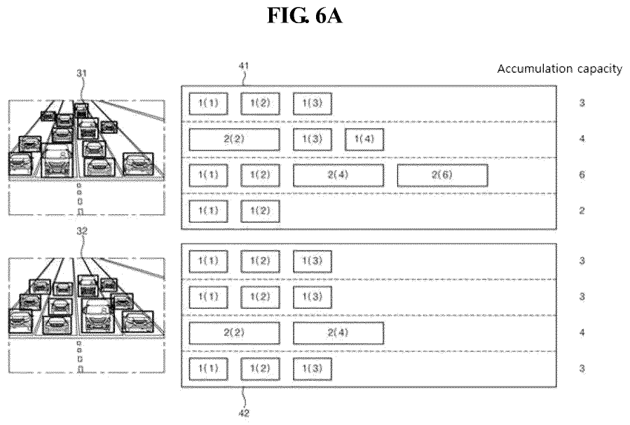

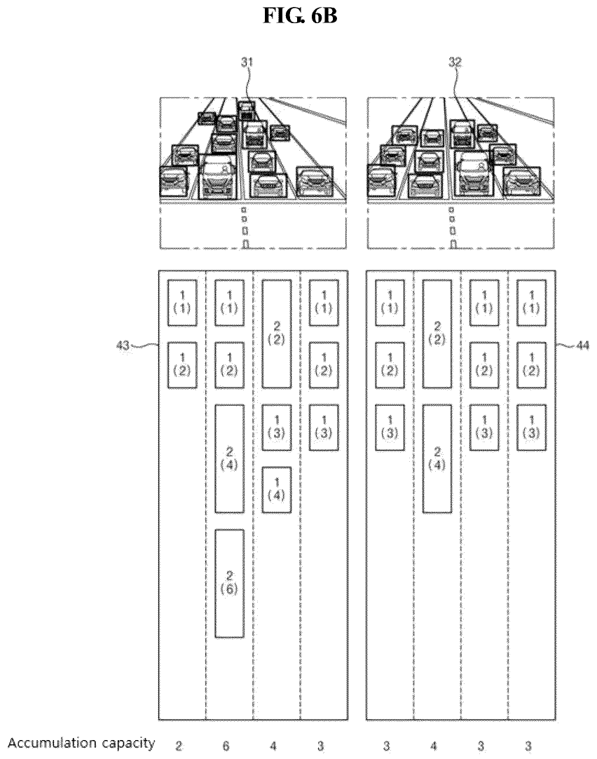

FIG. 6A and FIG. 6B are views illustrating an example showing a template generated by a system for controlling a traffic signal according to an embodiment of the disclosure.

In FIG. 6A, the simulation unit 140 may display a lane image 31 or 32 and a template 41 or 42 generated through the template generating unit 120 based on the lane image 31 or 32. For example, the simulation unit 140 may display adjacently top-bottom or left-right a first template 41 and a second template 42 so that an object in the first template 41 has the same driving direction as an object in the second template 42. For another example, the simulation unit 140 may dispose adjacently the first template 41 and the first lane image 31 and dispose adjacently the second template 42 and the second lane image 32 when it displays the templates 41 and 42. In an embodiment, the first lane image 31 and the second lane image 32 may be substantially identical to the first lane image 31 and the second lane image 32 in FIG. 3, respectively.

In an embodiment, the simulation unit 140 may dispose top-bottom or left-right the first template 41 and the second template 42 when it displays the template 41 and 42. For example, the simulation unit 140 disposes top-bottom the first template 41 and the second template 42 in FIG. 6A, and it disposes left-right a first template 43 and the second template 44 in FIG. 6B.

In an embodiment, the simulation unit 140 may correct the templates 41, 42, 43 or 44 so that a stop line of the first template 41 or 43 is matched with that of the second template 42 or 44. Moreover, the simulation unit 140 may correct the templates 41, 42, 43 or 44 so that a start point and an end point of the first template 41 or 43 are matched with those of the second template 42 or 44, respectively.

In an embodiment, the simulation unit 140 may dispose top-bottom or left-right the first lane image 31 corresponding to the lane and the second lane image 32 corresponding to the opposite lane or dispose selectively the first template 41 and the second template 42 on a top part, a bottom part, a left part or a right part of the first lane image 31 and the second lane image 32 when it displays the lane images 31 and 32 or the templates 41 and 42 through the traffic control simulation UI. In this case, a driving direction of an object, e.g., vehicle in each of the templates may be displayed in a direction selected from a group including a direction from right to left, a direction from left to right, a direction from top to bottom and a direction from bottom to top according to a location of each of templates.

In an embodiment, the simulation unit 140 may display one or more of waiting order, traffic volume and accumulation capacity of each of objects on each of the objects displayed on the first template 41 and the second template 42, through interworking with the capacity calculating unit 130. In an embodiment, the simulation unit 140 may display further at least one of the number of objects or accumulation capacity of total lanes on each of lanes in the template.

Now referring to FIG. 4, the system 100 for controlling the traffic signal may include further the occupancy calculating unit 150, the cut line setting unit 160 and the controller 170.

The occupancy calculating unit 150 may calculate occupancy of a lane and occupancy of an opposite lane based on accumulation capacity of each of objects waiting on respective lane calculated through the capacity calculating unit 130. For example, the occupancy calculating unit 150 may calculate occupancy corresponding to each of accumulation capacities based on whether an object corresponding to reference accumulation capacity and accumulation capacity higher than the reference accumulation capacity exists on each of the lanes. In an embodiment, the reference accumulation capacity may be calculated by using a theoretical calculation method for realizing maximum traffic flow in road design, e.g., intersection design or an empirical method considering normal traffic flow of a road, etc., and it may mean accumulation capacity corresponding to a green signal time preset by a signal controller. Here, the green signal time may be identical to a time required for passing a stop line or the intersection.

In an embodiment, the occupancy corresponding to each of accumulation capacities calculated by the occupancy calculating unit 150 may be limited as occupancy corresponding to specific accumulation capacity.

In an embodiment, the occupancy calculating unit 150 may assign occupancy corresponding to each of lanes. For example, the occupancy calculating unit 150 may assign evenly the occupancy of each of lanes according to the number of a lane marking in the lane or assign differently the occupancy of each of lanes depending on specific time or environment information. In an embodiment, the occupancy calculating unit 150 may assign 50% occupancy for each of lanes when two lanes exist. For another example, the occupancy calculating unit 150 may assign 25% occupancy per lane when four lanes exist. On the other hand, the same occupancy may not be assigned to each of lanes. In the event that two lanes exist, the occupancy calculating unit 150 may assign 30% occupancy to a first lane of the lanes and assign 70% occupancy to a second lane of the lanes. In an embodiment, the occupancy calculating unit 150 may assign occupancy corresponding to each of lanes based on a time or environment information.

In an embodiment, the occupancy calculating unit 150 may calculate occupancy corresponding to each of accumulation capacities based on occupancy assigned to a lane on which an object corresponding to each of accumulation capacities exists. For example, the occupancy calculating unit 150 may summate occupancies assigned to lanes on which an object corresponding to each of accumulation capacities exists and calculate occupancy corresponding to each of accumulation capacities based on the summating.

In an embodiment, the occupancy calculating unit 150 may determine that an object corresponding to each of accumulation capacities exists when the object corresponding to each of accumulation capacities does not exist but an object corresponding to accumulation capacity higher than each of accumulation capacities exists. For example, the occupancy calculating unit 150 may determine that the object corresponding to each of accumulation capacities exists and calculate occupancy by estimating occupancy depending on the determined result.

In an embodiment, the occupancy calculating unit 150 may calculate occupancy by giving different weight to the occupancy assigned to each of lanes, or calculate occupancy through various methods such as sum, average, weighed average or multiplication of occupancies assigned to each of lanes or feature extraction of traffic capacity.

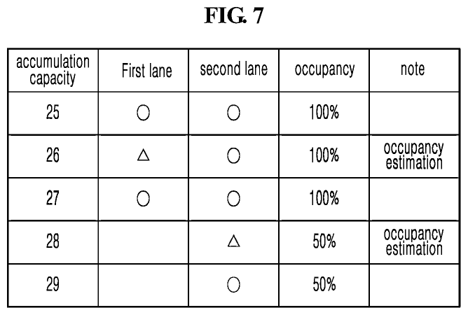

FIG. 7 is a view illustrating an example of calculating occupancy based on accumulation capacity in a system for controlling a traffic signal according to an embodiment of the disclosure.

In FIG. 7, the occupancy calculating unit 150 may calculate occupancy corresponding to each of accumulation capacities. For example, the occupancy calculating unit 150 may calculate occupancy corresponding to accumulation capacity more than accumulation capacity 25 which is reference accumulation capacity. For another example, the occupancy calculating unit 150 may determine the occupancy to 100% because objects exist on both of the first lane and the second lane when the accumulation capacity is 25. For still another example, since an object corresponding to accumulation capacity 26 does not exist on the first lane but an object corresponding to accumulation capacity 27 exists on the first lane when the accumulation capacity is 26, the occupancy calculating unit 150 may determine that the object corresponding to the accumulation capacity 26 exists. Additionally, the occupancy calculating unit 150 may determine (estimate) occupancy to 100% because an object corresponding to accumulation capacity 26 exists on the second lane. For still another example, since corresponding object does not exist on the first lane but exists on the second lane when the accumulation capacity is 29, the occupancy calculating unit 150 may determine the occupancy to 50%. This is a case that 50% occupancy is assigned to the first lane and the second lane, respectively. However, the occupancy calculating unit 150 may assign different occupancy to the first lane and the second lane and calculate occupancy based on the assigning.

Now referring to FIG. 4, the cut line setting unit 160 may set at least one cut line to the lane and the opposite lane based on occupancy of the lane and occupancy of the opposite lane. For example, the cut line setting unit 160 may calculate total occupancy by summating occupancy of the lane corresponding to each of accumulation capacities and occupancy of the opposite lane corresponding to each of accumulation capacities. Moreover, the cut line setting unit 160 may set accumulation capacity, which is more than reference accumulation capacity and its total occupancy is more than specific occupancy, as at least one cut line. In an embodiment, the cut line setting unit 160 may set an object for each of lanes corresponding to the accumulation capacity, which is more than reference accumulation capacity and its total occupancy is more than specific occupancy, as a cut line.

In an embodiment, the cut line setting unit 160 may set at least one object corresponding to multiple accumulation capacities, which are more than reference accumulation capacity and their total occupancy is more than specific occupancy, as one or more cut lines.

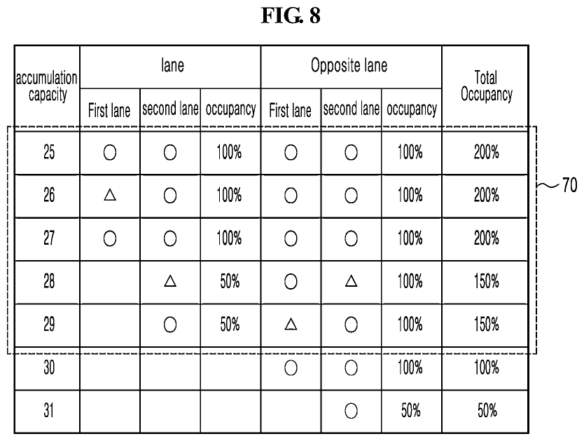

FIG. 8 is a view illustrating an example of setting a cut line using a system for controlling a traffic signal according to an embodiment of the disclosure.

In FIG. 8, the cut line setting unit 160 may calculate total occupancy by summating occupancy of the lane corresponding to accumulation capacity and occupancy of the opposite lane corresponding to the accumulation capacity. For example, the cut line setting unit 160 may determine total occupancy to 200% by summating occupancy 100% of the lane corresponding to accumulation capacity 25 and occupancy 100% of the opposite lane corresponding to the accumulation capacity 25. For another example, the cut line setting unit 160 may determine total occupancy to 150% by summating occupancy 50% of the lane corresponding to accumulation capacity 29 and occupancy 100% of the opposite lane corresponding to the accumulation capacity 29.

The cut line setting unit 160 may set accumulation capacity, which is more than reference accumulation capacity and its total occupancy is more than specific occupancy, as at least one cut line. For example, the cut line setting unit 160 may set at least one object corresponding to accumulation capacity in a range of 25 to 29 as one or more cut lines 70.

Now referring to FIG. 4, the controller 170 may set any one of at least one cut line as a final cut line. For example, the controller 170 may set the final cut line based on traffic situation or environment information of another opposite lane. In an embodiment, another opposite lane may mean another opposite lane in a single intersection or an opposite lane of another intersection such as previous intersection or sequential intersection, etc. In an embodiment, the environment information may include at least one of a pedestrian waiting line of a crosswalk, arrival of vehicle group in previous intersection or not, sharply increasing of vehicles or not and information concerning accumulation capacity of another lane.

In an embodiment, the controller 170 may generate a control signal for controlling a signal time of a signal controller based on the final cut line. For example, the controller 170 may calculate a time required for passing a stop line or the intersection (or a green signal time of a signal light) corresponding to the final cut line, and generate the control signal depending on the calculated time.

In an embodiment, the controller 170 may correct reference accumulation capacity and specific occupancy based on traffic situation or environment information of another opposite lane, the reference accumulation capacity being a reference for setting the cut line by the cut line setting unit 160. For example, the specific occupancy may include occupancy calculated through the occupancy calculating unit 150. For another example, the specific occupancy may include reference occupancy for setting the cut line by the cut line setting unit 160.

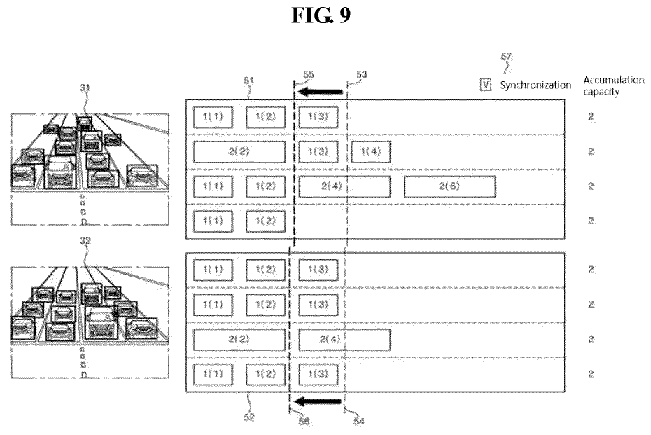

FIG. 9 is a view illustrating an example marking a cut line using a system for controlling a traffic signal according to an embodiment of the disclosure.

The simulation unit 140 may mark a cut line 53 or 54 set by the cut line setting unit 160 or the controller 170 on a template. For example, the simulation unit 140 may mark a first cut line 53 on a first template 51 and mark a second cut line 52 on a second template 52. In an embodiment, the first template 51 and the second template 52 may be substantially identical to the first template 41 and the second template 42 in FIG. 6A, respectively.

In an embodiment, the simulation unit 140 may mark the cut lines 53 and 54 on the first template 51 and the second template 52. For example, the simulation unit 140 may mark a final cut line set by the controller 170 or the cut line set by a cut line setting unit 160 on the first template 51 and the second template 52.

In an embodiment, the simulation unit 140 may display a time required for passing a stop line or an intersection corresponding to the cut line marked on the template 51 or 52 through the traffic control simulation UI while it interworks with the cut line setting unit 160 and the controller 170. For example, the controller 170 may store information concerning a time required for passing the stop line or the intersection of an object preset for each of accumulation capacities of the object, and calculate the time, required when an object passes the stop line or the intersection, corresponding to accumulation capacity of an object corresponding to a final cut line by using the stored information.

In an embodiment, the simulation unit 140 may provide a function of setting the first cut line 53 or the second cut line 54 through the traffic control simulation UI as described above. Accordingly, the user may set the first cut line 53 and the second cut line 54 on each of templates through the traffic control simulation UI and change the set first cut line 53 and the set second cut line 54.

In an embodiment, the simulation unit 140 may display a synchronization check box 57 through the traffic control simulation UI to synchronize and display automatically a shift location of the cut line on the template 52 related to the lane image 32 of the opposite lane of specific lane when the cut line is shifted on the template 51 related to the lane image 31 of specific lane according to user's input.

In an embodiment, the simulation unit 140 may shift the second cut line 54 by synchronizing with at least one of the number of objects, traffic volume, accumulation capacity or a time required for passing calculated by the shift of the first cut line 53 when the first cut line 53 shifts in a direction approached to a stop line or in a direction receded from the stop line in response to the user's input after the user checks the synchronization check box 57, i.e., activates a synchronization function.

For example, the simulation unit 140 may display at least one of the number of an object, traffic volume, accumulation capacity or a time required for passing for each of lanes corresponding to a changed first cut line 55 or a changed second cut line 56 through the traffic control simulation UI when the first cut line 53 or the second cut line 54 is changed by shifted. For example, the number of the objects for each of lanes corresponding to the cut line may mean sum of the number of objects located between the cut line and the stop line. The traffic volume for each of lanes corresponding to the cut line may indicate traffic volume of an object adjacent to the cut line (for example an object nearest to the cut line of objects located between the cut line and the stop line) or overlapped object. The accumulation capacity for each of lanes corresponding to the cut line may mean accumulation capacity of an object adjacent to the cut line (for example an object nearest the cut line of objects located between the cut line and the stop line) or overlapped object. The time, required for passing, for each of lanes corresponding to the cut line may indicate a time required for passing the stop line or the intersection calculated by the controller 170 based on the accumulation capacity of an object adjacent to the cut line (for example an object nearest the cut line of the objects located between the cut line and the stop line) or overlapped object.

In another example, the simulation unit 140 may set to shift the second cut line 54 by the same a shift distance as the first cut line 53 in the same shift direction as the first cut line 53 and display the shifted second cut line 54 when the first cut line 53 is shifted according to user's input after the user checks the synchronization check box 57, i.e., activates a synchronization function. Additionally, the simulation unit 140 may set to shift the first cut line 53 by the same shift distance as the second cut line 54 in the same shift direction as the second cut line 54 and display the shifted first cut line 53 when the second cut line 54 is shifted according to user's input. For example, in the event that any one of the first cut line 53 and the second cut line 54 is shifted in a direction of the stop line, the other cut line may be set to shifted in a direction of the stop line and the shifted other cut line may be displayed.

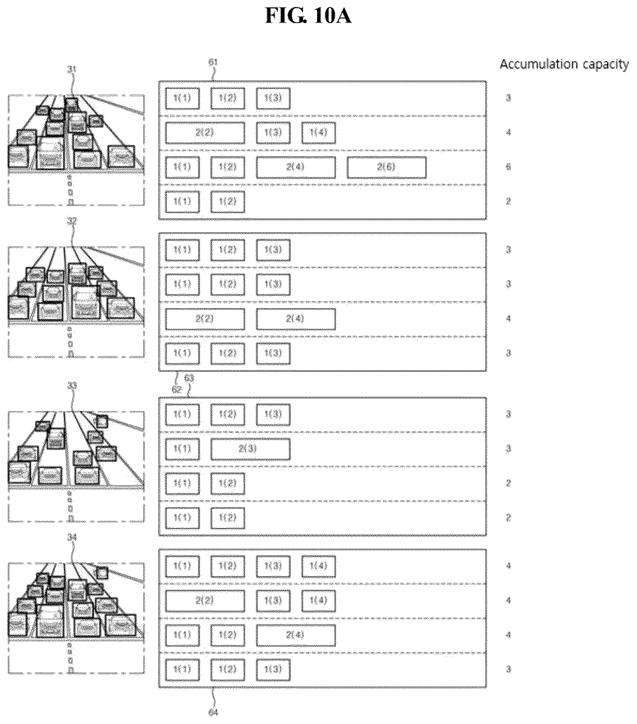

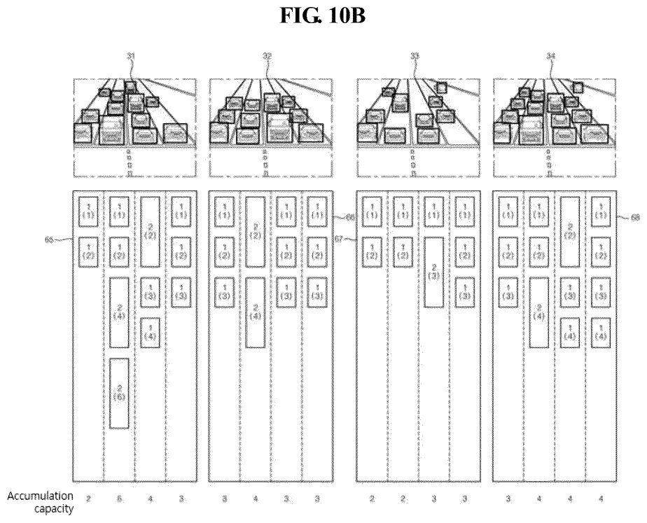

FIG. 10A and FIG. 10B are views illustrating an example of showing a template generated by a system for controlling a traffic signal according to another embodiment of the disclosure.

In FIG. 10A, the template generating unit 120 of the system 100 for controlling a traffic signal according to the present embodiment may generate a first template 61 related to a lane, a second template 62 related to an opposite lane, a third template 63 related to another lane different from the lane and the opposite lane and a fourth template 54 related to another opposite lane corresponding to another lane. For example, the template generating unit 120 may generate the first template 61 based on a first lane image 31, generate the second template 62 depending on a second lane image 32, generate the third template 63 based on a third lane image 33 and generate the fourth template 64 depending on a fourth lane image 34. In an embodiment, the first lane image 31, the second lane image 32, the third lane image 33 and the fourth lane image 34 may be lane images for each of directions of a four-way intersection in FIG. 3. That is, the first lane image 31 and the second lane image 32 may be images of lanes opposed each other, and the third lane image 33 and the fourth lane image 34 may be images of lanes opposed each other.

The simulation unit 140 may display the first template 61, the second template 62, the third template 63 and the fourth template 64 with the first lane image 31, the second lane image 32, the third lane image 33 and the fourth lane image 34 through the traffic control simulation UI. Here, the simulation unit 140 may dispose adjacently top-bottom or left-right the first template 61, the second template 62, the third template 63 and the fourth template 64 so that objects included in the first template 61, the second template 62, the third template 63 and the fourth template 64 have the same driving direction when it displays the templates 61 to 64.

The simulation unit 140 may dispose adjacently the first to fourth lane images 31 to 34 and the first to fourth templates 61 to 64 corresponding to each of the lane images 31 to 34 when it displays the lane images 31 to 34 and the templates 61 to 64. For example, the simulation unit 140 may dispose top-bottom the first to fourth lane images 31 to 34 and the first to fourth templates 61 to 64 corresponding to each of the lane images 31 to 34 as shown in FIG. 10A, or dispose left-right the first to fourth lane images 31 to 34 and the first to fourth templates 61 to 64 as shown in FIG. 10B when it displays the lane images 31 to 34 and the templates 61 to 64.

In an embodiment, the simulation unit 140 may display further accumulation capacity of each of lanes calculated by the capacity calculating unit 130 through the traffic control simulation UI.

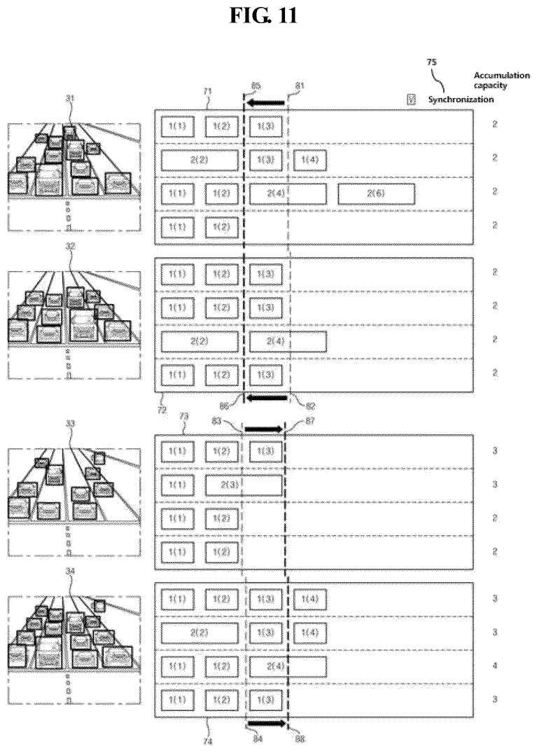

FIG. 11 is a view illustrating an example of marking a cut line using a system for controlling a traffic signal according to another embodiment of the disclosure.

In FIG. 11, the simulation unit 140 of the system 100 for controlling a traffic signal according to the present embodiment may include a first template 71, a second template 72, a third template 73 and a fourth template 74. For example, the first template 71, the second template 72, the third template 73 and the fourth template 74 may be substantially identical to the first template 61, the second template 62, the third template 63 and the fourth template 64, respectively.

The simulation unit 140 may mark a first cut line 81, a second cut line 82, a third cut line 83 and a fourth cut line 84 on the first template 71, the second template 72, the third template 73 and the fourth template 74. For example, the first cut line 81, the second cut line 82, the third cut line 83 and the fourth cut line 84 may be generated by the cut line setting unit 160.

In an embodiment, the simulation unit 140 may display a synchronization check box 75 for setting to shift other cut lines by synchronizing with a shifted cut line and displaying the shifted other cut lines when any one of the first cut line 81, the second cut line 82, the third cut line 83 and the fourth cut line 84 is shifted according to user's input through the traffic control simulation UI. In this case, the simulation unit 140 may synchronize the shift of the first cut line 81, the second cut line 82, the third cut line 83 and the fourth cut line 84 according to the user's input, after the synchronization check box 75 is checked, i.e., a synchronization function is activated.

In an embodiment, the simulation unit 140 may shift other cut lines, i.e., the second cut line 82, the third cut line 83 and the fourth cut line 84 by synchronizing with at least one of the number of objects, traffic volume, accumulation capacity or a time required for passing calculated by the shift of the first cut line 81 and display the shifted other cut lines when the first cut line 81 shifts in a direction approached to a stop line or in a direction receded from the stop line.

In an embodiment, the simulation unit 140 may provide a synchronization selecting input unit (not shown) through which a user can input selectively a cut line to be shifted by synchronized with the first cut line of other cut lines. The synchronization selecting input unit may be displayed and provided in a check box type through the traffic control simulation UI.

In another embodiment, the simulation unit 140 may set to shift the second cut line 82 set and marked on the second template 72 related to a lane image of an opposite lane by the same shift distance as the first cut line 81 in the same shift direction as the first cut line 81 and display the shifted second cut line 82 when the first cut line 81 is shifted. Whereas, the simulation unit 140 may set to shift the third cut line 83 and the fourth cut line 84 set and marked on the third template 73 and the fourth template 74 related to lane images 33 and 34 of each of a lane, an opposite lane of the lane, another lane and an opposite lane of another lane by the same shift distance as the first cut line 81 in a shift direction opposed to the first cut line 81 and display the shifted third cut line 83 and the shifted fourth cut line 84. For example, the simulation unit 140 may shift the third cut line 83 and the fourth cut line 84 in a direction receded from a stop line and display the shifted cut lines 83 and 84 when any one of the first cut line 81 or the second cut line 82 is shifted in a direction approached to the stop line. Additionally, the simulation unit 140 may shift the third cut line 83 and the fourth cut line 84 by the same shift distance as a first cut line 85 or a second cut line 86, shifted in the direction approached to the stop line, in the direction receded from the stop line and display the shifted cut line 83 and the shifted fourth cut line 84.

FIG. 11 shows a case that the first cut line 81 or the second cut line 82 is shifted in the direction approached to the stop line, but it is not limited as the case. The simulation unit 140 may shift the third cut line 83 and the fourth cut line 84 in the direction approached to the stop line and display the shifted third cut line 83 and the shifted fourth cut line 84 when any one of the first cut line 81 or the second cut line 82 is shifted in the direction receded from the stop line.

In an embodiment, the simulation unit 140 may shift the first cut line 81 and the second cut line 82 through a method similar to the above method and display the shifted cut line 81 and the shifted cut line 82 when an input for shifting any one of the third cut line 83 or the fourth cut line 84 is received.

In an embodiment, the simulation unit 140 may display further a time required for passing a stop line or an intersection in accordance with setting and display of a cut line through interworking with the controller 170. For example, the time may be calculated based on accumulation capacity by the controller 170.

In an embodiment, the simulation unit 140 may calculate at least one of the number of objects, traffic volume, accumulation capacity or a time required for passing for each of lanes corresponding to a changed cut line and display the calculated result through the traffic control simulation UI when the first cut line 81, the second cut line 82, the third cut line 83 or the fourth cut line 84 is changed by shifted. For example, the number of the object for each of lanes corresponding to the cut line may mean sum of the number of objects located between the cut line and the stop line. The traffic volume for each of lanes corresponding to the cut line may indicate traffic volume of an object adjacent to the cut line (for example an object nearest to the cut line of objects located between the cut line and the stop line) or overlapped object. The accumulation capacity for each of lanes corresponding to the cut line may mean accumulation capacity of an object adjacent to the cut line (for example an object nearest the cut line of objects located between the cut line and the stop line) or overlapped object. The time, required for passing, for each of lanes corresponding to the cut line may indicate a time required for passing the stop line or the intersection calculated by the controller 170 based on the accumulation capacity of an object adjacent to the cut line (for example an object nearest the cut line of the objects located between the cut line and the stop line) or overlapped object.

Now referring to FIG. 1, the operating device 300 may be a device established to a control center for controlling traffic flow based on information received from the system 100 for controlling the traffic signal and include every element or at least one element of the system 100. For example, the operating device 300 may include the simulation unit 140 of the system 100. In this case, a user of the control center may simulate traffic control and traffic flow of a road, e.g., an intersection at a remote location through the traffic control simulation UI and apply the simulated result to a traffic signal system in practice.

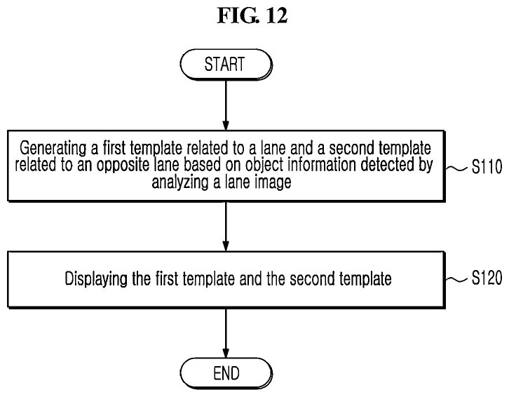

FIG. 12 is a flowchart illustrating a process of controlling a traffic signal according to an embodiment of the disclosure.

In FIG. 12, a method of operating the system 100 for controlling the traffic signal according to the present embodiment may include a step of S110 of generating a first template related to a lane and a second template related to an opposite lane of the lane based on object information detected by analyzing a lane image and a step of S120 of displaying the generated first template and the generated second template.

In the step of S110, the object detecting unit 110 may detect the object information by analyzing the lane image. The template generating unit 120 may generate the first template related to the lane and the second template related to the opposite lane based on the object information.

In the step of S120, the simulation unit 140 may display the first template, the second template and the lane image. For example, the simulation unit 140 may match a start point and an end point of the first template with a start point and an end point of the second template and display adjacently top-bottom or left-right the first template and the second template so that objects included in the first template and the second template have the same driving direction. Furthermore, the simulation unit 140 may display a first lane image corresponding to the first template and a second lane image corresponding to the second template at a location adjacent to the first template and the second template, respectively.

Although embodiments have been described with reference to a number of illustrative embodiments thereof, it should be understood that numerous other modifications and embodiments can be devised by those skilled in the art that will fall within the spirit and scope of the principles of this disclosure.

Accordingly, embodiments in the disclosure are for explaining technical thought not limiting the technical thought, and a range of the technical thought disclosed in the disclosure is not limited by the embodiments. Protection scope of the technical thought disclosed in the disclosure is interpreted by following claims, and it will be interpreted that every equivalent technical thought is included in right scope of the disclosure.

What is claimed is:

1. A system for controlling a traffic signal comprising:
a template generating unit configured to generate a first template related to a lane and a second template related to an opposite lane of the lane based on object information detected by analyzing a lane image; and
a simulation unit configured to display the first template and the second template.

2. The system of claim 1, wherein the simulation unit disposes adjacently top-bottom or left-right the first template and the second template so that a driving direction of an object included in the first template is identical to a driving direction of an object included in the second template.

3. The system of claim 1, wherein the simulation unit disposes a first lane image corresponding to the first template at a location adjacent to the first template, and disposes a second lane image corresponding to the second template at a location adjacent to the second template.

4. The system of claim 1, wherein the simulation unit displays adjacently a third template related to another lane different from the lane and the opposite lane and a fourth template related to another opposite lane of the another lane generated through the template generating unit.

5. The system of claim 4, wherein the simulation unit displays adjacently top-bottom or left-right the first template, the second template, the third template and the fourth template so that objects included in the first template, the second template, the third template and the fourth template have the same driving direction.

6. The system of claim 1, wherein the template generating unit generates the first template and the second template by converting an object in a figure type based on the object information.

7. The system of claim 1, wherein the simulation unit corrects the first template and the second template so that a stop line included in the first template is matched with a stop line included in the second template.

8. The system of claim 1, wherein the simulation unit marks at least one of a waiting order, traffic volume or accumulation capacity of each of objects on the first template and the second template.

9. The system of claim 1, wherein the simulation unit marks at least one of the number of objects or accumulation capacity of every lane on each of lanes in the first template and the second template.

10. The system of claim 8, further comprising:
a capacity calculating unit configured to calculate the accumulation capacity based on the traffic volume of each of objects.

11. The system of claim 1, wherein the simulation unit displays further a first cut line and a second cut line on the first template and the second template, respectively.

12. The system of claim 11, wherein the simulation unit shifts the second cut line by synchronizing with change of at least one of the number of objects, traffic volume, accumulation capacity or a time required for passing calculated by a shift of the first cut line and displays the shifted second cut line when the first cut line is shifted.

13. The system of claim 11, wherein the simulation unit shifts the second cut line by the same shift distance as the first cut line in the same shift direction as the first cut line and displays the shifted second cut line when the first cut line is shifted, and shifts the first cut line by the same shift distance as the second cut line in the same shift direction as the second cut line and displays the shifted first cut line when the second cut line is shifted.

14. The system of claim 12, wherein the simulation unit calculates at least one of the number of objects, traffic volume, accumulation capacity of a time required for passing for each of lanes corresponding to a changed cut line and displays the calculated result when the first cut line or the second cut line is changed by shifted.

15. The system of claim 11, wherein the simulation unit displays a third template related to another lane different from the lane and the opposite lane and a fourth template related to another opposite lane of the another lane generated through the template generating unit, marks respectively a third cut line and a fourth cut line on the third template and the fourth template, and
shifts the second cut line, the third cut line and the fourth cut line by synchronizing with change of at least one of the number of objects, traffic volume, accumulation capacity or a time required for passing calculated by a shift of the first cut line and displays the shifted second cut line, the shifted third cut line and the shifted fourth cut line when the first cut line is shifted.

16. The system of claim 11, wherein the simulation unit displays a third template related to another lane different from the lane and the opposite lane and a fourth template related to another opposite lane of the another lane generated through the template generating unit, marks respectively a third cut line and a fourth cut line on the third template and the fourth template, and
shifts the second cut line by the same shift distance as the first cut line in the same shift direction as the first cut line, display the shifted second cut line, shifts the third cut line and the fourth cut line by the same shift distance as the first cut line in a direction opposed to the first cut line and displays the shifted third cut line and the shifted fourth cut line when the first cut line is shifted.

17. The system of claim 15, wherein the simulation unit provides a synchronization selecting input unit so that a user inputs selectively a cut line to be shifted by synchronized with the first cut line.

18. The system of claim 15, wherein the simulation unit calculates at least one of the number of objects, traffic volume, accumulation capacity of a time required for passing for each of lanes corresponding to a changed cut line and displays the calculated result when the first cut line, the second cut line, the third cut line or the fourth cut line is changed by shifted.

19. The system of claim 1, wherein the opposite lane includes at least one lane passable at a simultaneous entry signal of an intersection between the lane and the intersection.

20. A method of controlling a traffic signal, the method comprising:
generating a first template related to a lane and a second template related to an opposite lane of the lane based on object information detected by analyzing a lane image; and
displaying the first template and the second template.
